(19) United States
(12) Patent Application Publication
(10) Pub. No.: US 2013/0284924 A1
(43) Pub. Date: Oct. 31, 2013

(54) CHARGED PARTICLE BEAM APPARATUS

(71) Applicants: Masaki Mizuochi, Hitachinaka (JP); Tetsuya Niibori, Mito (JP)

(72) Inventors: Masaki Mizuochi, Hitachinaka (JP); Tetsuya Niibori, Mito (JP)

(73) Assignee: HITACHI HIGH-TECHNOLOGIES CORPORATION, Tokyo (JP)

(21) Appl. No.: 13/997,941

(22) PCT Filed: Nov. 9, 2011
(86) PCT No.: PCT/JP2011/006247

§ 371 Date: Jun. 25, 2013

(30) Foreign Application Priority Data
Jan. 14, 2011 (JP) 2011-005381

(51) Int. Cl. G01N 23/22

(52) U.S. Cl. CPC G01N 23/2206
USPC 250/310

(57) ABSTRACT

There is provided an apparatus which can accurately carry out focusing of an optical microscope mounted on a charged particle beam apparatus while restraining an increase in an apparatus cost and a reduction in a throughput. An approximate polynomial is formed based on a focus map of the optical microscope which is previously measured, and a control amount which adds a difference between a piece of wafer height information at that occasion and a piece of wafer height information in actual observation to the approximate polynomial is inputted as a focus control value of the optical microscope.

### TECHNICAL FIELD

The present invention relates to a charged particle beam apparatus of an electron microscope, an ion beam processing/observing apparatus or the like having an optical microscope.

### BACKGROUND ART

In recent years, an integration degree of a semiconductor product is more and more increased, and a higher fineness of a circuit pattern has been requested. Various inspection means are used in a sample which is formed with a circuit pattern that is represented by a semiconductor wafer with an object of quality control, and an increase in yield. For example, there are pointed out a scanning electron microscope (hereinafter, referred to as length measuring SEM) which measures a dimensional accuracy of a circuit pattern by irradiating the circuit pattern with a charged particle beam, a scanning electron microscope (hereinafter, referred to as review SEM) which evaluates a defect of a circuit pattern, or an attached foreign matter by similarly irradiating the circuit pattern with a charged particle beam and so on.

When a wafer is observed by an electron microscope, a wafer alignment is carried out by using an optical microscope in background arts. This is because an observation which uses a charged particle beam having a high observation magnification at an initial stage is difficult, since a position of loading a wafer on a sample stage is dispersed at each time of loading the wafer. In the wafer alignment, a coordinate system of a stage control and a physical coordinate system on a wafer are made to coincide with each other by carrying out a correction of rotation, shifting, scaling or the like of the wafer by detecting plural pieces of specific patterns on the wafer positions of which are already known, and measuring positions of patterns at that occasion by using an optical microscope having a low observation magnification. Thereby, an observation is enabled by moving a desired pattern in an observation range of a charged particle beam.

On the other hand, there is a request for intending to observe a small foreign matter or a defect by an electron beam with a high magnification also with regard to a nonpatterned wafer (bare wafer) which is not formed with a circuit pattern. At that occasion, the observation is frequently processed by the following flow.

(1) A foreign matter/defect is detected and information of a wafer coordinate at that occasion is acquired by an optical foreign matter/defect inspection apparatus.
(2) The foreign matter/defect is detected and the coordinate information at that occasion is acquired by an optical microscope based on the acquired wafer coordinate information.
(3) The wafer is moved and observed by an electron beam based on the coordinate information which is acquired at (2) described above. Here, the reason of acquiring again the coordinate information by the optical microscope at (2) is that there is an error between coordinates of apparatus at the optical foreign matter/defect inspection apparatus at (1) and the electron beam apparatus, and the foreign matter or the defect which is an observation object is not put into an observation visible field of the electron beam having the high magnification when the state is as it is. The coordinate error between the apparatus can be absorbed by detecting the foreign matter/defect by an optical microscope having a wide visible view at (2) and acquiring an accurate coordinate of the electron beam apparatus.

A focal point needs to be adjusted also when an image is taken by an optical microscope, and when automatic image taking is intended to carry out, a focal point adjustment also needs to be automated. As an automatic adjustment of a focal point in this way, that is, an autofocusing method, for example, Japanese Unexamined Patent Application Publication No. 2000-098069 (Patent Literature 1) discloses an invention of carrying out autofocusing of an optical microscope by determining a focused state of the optical microscope from an image signal of a reflection pattern in a slit-like shape which is obtained by projecting a slit-like pattern onto a sample surface.

Also, Japanese Unexamined Patent Application Publication No. 2009-259878 (Patent Literature 2) discloses an invention which carries out a focusing control by measuring a height of a virtual mesh center position that is formed on a wafer by a height sensor (Z sensor), and regarding a height of an observation position that is present in the same area substantially as the same height by the measured height information. According to the invention, when a focusing adjustment of an optical microscope is carried out, it is not necessary to measure an image taking location of the optical microscope at each time, focusing of plural image taking locations can be carried out by the Z sensor measured value of one time, and an observation throughput is improved.

### CITATION LIST

### Patent Literature

Patent Literature 1: Japanese Unexamined Patent Application Publication No. 2000-090869
Patent Literature 2: Japanese Unexamined Patent Application Publication No. 2009-259878

### SUMMARY OF INVENTION

### Technical Problem

The smaller the observation object, the higher the resolving power of an optical microscope is needed. Thereby, large N/A is requested for an optical lens while maintaining a wide observation range to some degree, and the optical lens is necessarily large-sized. Therefore, there is brought about a situation in which an optical microscope that is installed at an inner portion of a column in a background art needs to be installed on an outer side of the column. On the other hand, a Z sensor which acquires wafer height information that is necessary for focusing control of SEM can reduce a detection error when the Z sensor is arranged directly below the column as much as possible, and more accurate focusing of SEM is enabled. Therefore, in order to use the wafer height information of the Z sensor in the optical microscope, it is necessary to observe the observed wafer position by moving a wafer coordinate thereof to the optical microscope after once measuring the height information by the Z sensor which is disposed directly below the column. This signifies that a distance of moving the wafer is made to be longer than that of a background art, and a throughput is reduced by that amount.

Although there is conceivable a method of mounting the Z sensor directly below the optical microscope, two pieces of the Z sensors are mounted, which amounts to an increase in an apparatus cost.

Also according to a method of described in Patent Literature 2, although the coarser the mesh division, the more increased the number of times of capable of saving a height measurement by a Z sensor, an error from an actual height is increased by that amount, and a focusing error (dimming) is increased. Therefore, although the mesh division is made to be fine to some degree, measuring points by the Z sensor are increased by that amount, and therefore, the throughput is increased.

It is an object of the present invention to realize a charged particle beam apparatus which can shorten focus adjusting time more than in background arts while restraining an increase in an apparatus cost in a charged particle beam apparatus which is provided with an optical microscope and a charged particle beam microscope.

### Solution to Problem

According to the present invention, a height of a pertinent reference position on a wafer and focus values of an optical microscope at plural positions of in-plane positions of the wafer are previously measured, and stored to a storage means of memory, a hard disk, or the like as correction data. The focus value at an image taking position of the optical microscope is predicted by using a piece of information of a dependency of the obtained focus value on the in-plane position of the wafer, and the value is used as a focus value of the optical microscope. At that occasion, a height of the reference position is measured by a height sensor (Z sensor), a difference from the measured value of the height of the correction value is added to the predicted focus value as an offset value, and the focus value is corrected. The focus value after the correction is used for adjusting a focus of an actual optical microscope. Here, the piece of information of the dependency of the focus value on the in-plane position of the wafer for example, an approximate function which fits the focus values at the plural in-plane positions of the wafer by a piece of position information expressed by a pertinent coordinate system.

### Advantageous Effects of Invention

In autofocusing of the optical microscope, it is not necessary to measure the height of the image taking position by the Z sensor at each time of executing autofocusing, it is not necessary to take an image for focusing determination, and therefore, a throughput per the sheet of the wafer is remarkably improved than in background arts.

### BRIEF DESCRIPTION OF DRAWINGS

FIG. 1 is a plane view showing a total of an apparatus according to the present invention;

FIG. 2 is a plane view of a sample chamber;

FIG. 3 is a total operation diagram of a review apparatus according to a first embodiment;

FIG. 4 is an explanatory diagram showing an alignment function of the present invention;

FIG. 5 is a focus map by an optical microscope;

FIG. 6 shows an approximate curve using an approximate polynomial which is calculated based on the focus map;

FIG. 7 is a conceptual diagram showing an error by an inclination of a wafer;

FIG. 8 is an approximate curve using an approximate polynomial which is formed in a state of interposing a foreign matter;

FIG. 9 is an approximate curve showing a focusing shift;

FIG. 10 is a flow of forming an approximate polynomial which excludes an influence of a foreign matter; and

FIG. 11 is a plane view of a stage.

### DESCRIPTION OF EMBODIMENTS

An explanation will be given of embodiments in reference to the drawings as follows. Incidentally, although in the following explanation, an explanation will be given of a configuration of a defect review SEM using a scanning electron microscope as an example of a charged particle beam apparatus, the present invention can generally be applied to a charged particle beam apparatus of an ion microscope other than an electron beam applying apparatus such as a length measuring SEM or an electron beam type outlook inspection apparatus.

### First Embodiment

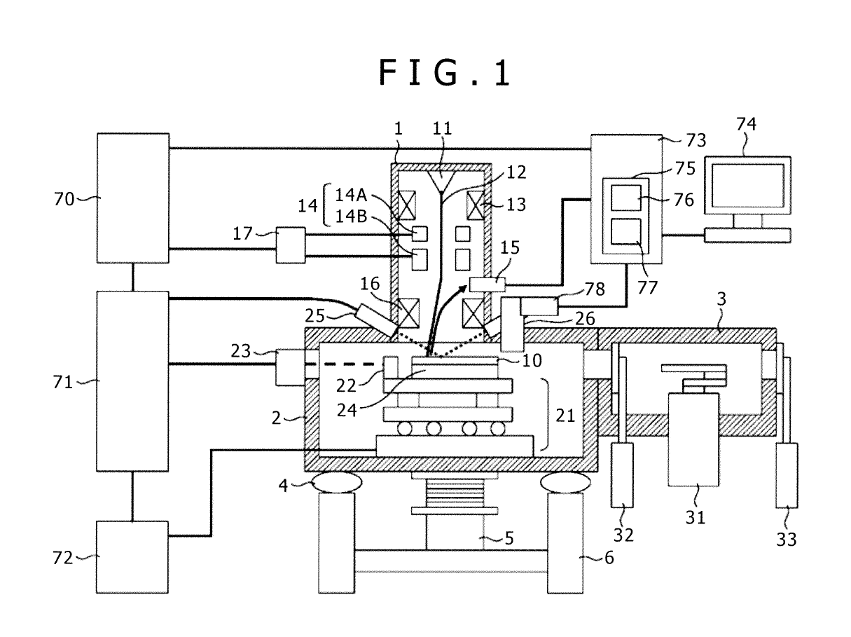

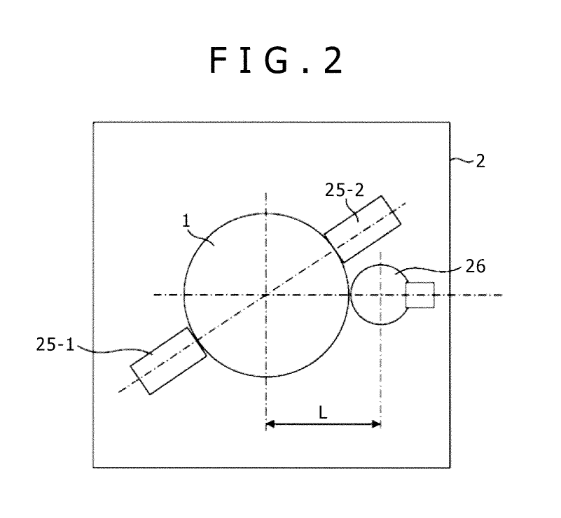

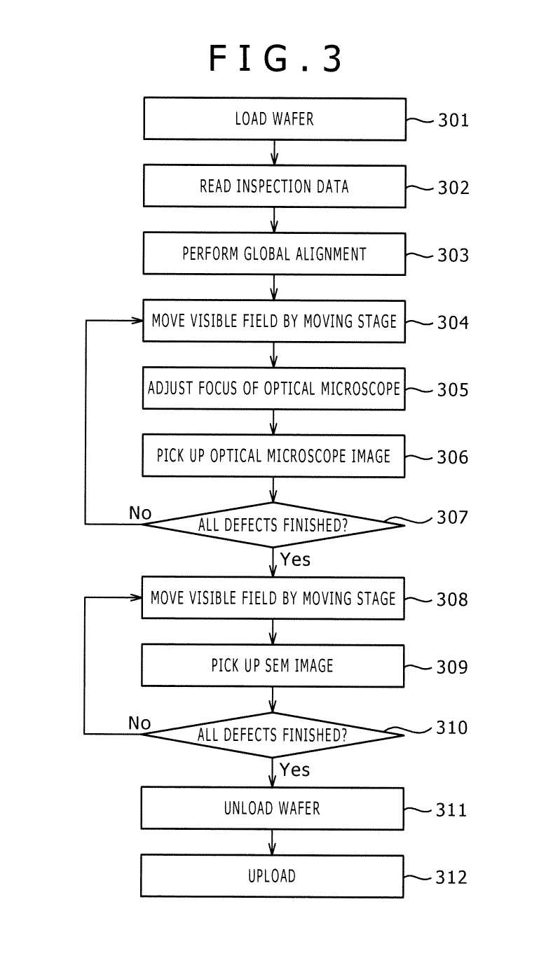

An explanation will be given of a configuration of a review SEM according to the present embodiment in reference to FIG. 1, FIG. 2, and FIG. 3.

First, an explanation will be given of an apparatus configuration shown in FIG. 1.

A frame 6 which is installed on a floor is attached with a mount 4 of removing a floor vibration, and the mount 5 supports a sample chamber 2. The sample chamber 2 is attached with a charged particle optical column 1 which generates a primary charged particle beam (primary electron beam in a case of the present embodiment), and focuses the primary charged particle beam onto a sample (hereinafter, abbreviated as column), and a load lock chamber 3 which incorporates a carrier robot 31 that carries the sample. The charged particle optical column 1 is attached with a secondary electron detector and a reflection electron detector, detects a secondary electron which is generated by primary electron irradiation or a reflection electron which is back-scattered, and outputs the electron as a detection signal. The sample chamber is always vacuum-exhausted by a vacuum pump 5, and also an inside of the column 1 is maintained at a high vacuum degree by a vacuum pump, not illustrated. On the other hand, the load lock chamber 3 is attached with an atmosphere side gate valve 33 which carries out an isolation from the atmosphere, and a vacuum side gate valve 32 which carries out an isolation from the sample chamber 2.

An electron beam 12 which is generated by an electron gun 11 in the column 1 passes through an electron lens 13 and an electron lens 16 which have a focusing operation, reflected to a desired trajectory by a deflector 14, and thereafter, irradiated to a wafer 10. A reflection electron, or a secondary electron which is generated by irradiating the electron beam is detected by a detector 15, and transferred to an image control unit 73 along with control information of the deflector 14. Here, an image is generated based on the control information of the deflector and the information obtained from the detector, and is described to a monitor which is provided at a control computer 74 as an image.

An upper side of the sample chamber 2 is attached with an optical type Z sensor 25 which detects a height of a wafer, and the height of the wafer can always be monitored. A signal which is obtained by the Z sensor 25 is converted into height information by a position control unit 71 and is transferred to a column control unit. The column control unit changes an optical condition of the electron lens by using a measured value of the Z sensor 25, and processes the optical condition so as not to shift focusing even when the height of the wafer is changed.

An optical microscope 26 is provided contiguous to the column 1 at a ceiling face of the sample chamber 2. FIG. 2 is an upper view which views an arrangement of the column 1 and the optical microscope 26 from above the sample chamber 2. One-dotted chain lines in FIG. 2 designate moving axes in X and Y directions of a stage 21 and correspond also to center axes in X and Y directions of the column 1 and the optical microscope 26 at the same time. The column 1 and the optical microscope 26 are arranged to align in X direction above the sample chamber 2, and center axes in Z direction are arranged to be remote from each other by a distance L. A light emitting unit 25-1 and a light receiving unit 25-2 of the Z sensor 25 are arranged to be opposed to each other in a direction which is inclined to the moving axis of the stage. In a case of carrying out a high magnification observation by SEM, a measurement error of the Z sensor needs to be reduced since a depth of focus of the electron beam is reduced. It is preferable to arrange the Z sensor directly below the column as shown in FIG. 2 for that purpose. Thereby, a height of a primary electron beam irradiating position directly below the column can be measured. Incidentally, the optical microscope 26 may be a bright-field type optical microscope or a dark-field type optical microscope, and may include both of the bright-field type optical microscope and the dark-field type optical microscope.

Here, a brief explanation will be given of a route of carrying a sample (hereinafter, made to be a wafer).

The atmosphere side gate side valve 33 is opened, and the wafer 10 is introduced into the load lock chamber 3 from the atmosphere side by the carrier output 31. When the atmosphere gate valve 33 is closed, inside of the load lock chamber 3 is vacuum-exhausted by a vacuum pump, not illustrated, and a vacuum degree becomes a degree the same as that in the sample chamber 2, the vacuum side gate valve 32 is opened, and the wafer 10 is carried onto the stage 21 which is incorporated in the sample chamber 2 by the carrier robot 31. After processing the wafer 10, the wafer is returned to the atmosphere by passing the load lock chamber 3 by a reverse flow.

The wafer 10 is electrostatically adsorbed by an electrostatic chuck 24 which is attached to the stage 21, strongly held above the stage 21, and corrected also with regard to a deformation of warp or the like, and a flatness degree thereof is improved to a degree of a flatness degree of an upper face of the electrostatic chuck. A bar mirror 22 is attached above the stage 21, and a wafer position above the stage can be controlled by measuring a change in a distance relative to an interferometer 23 which is attached to the sample chamber 2 by laser. Position information of the stage is generated by the position control unit 71, and is transferred to a stage control unit 72 which drives the stage.

When the wafer is loaded, first, a specific pattern is observed by the optical microscope 26 having a wide visible field in order to carryout coordinate correction that is referred to as a wafer alignment. Ordinarily, the optical microscope is mounted with an actuator 78 which carries out focusing control, and mainly controls the object lens in a height direction. As the actuator 78, there is an actuator which uses, for example, a combination of a stepping motor and a ball screw, a stepping motor and a cam, or a piezoelectric element which can carry out a fine control or the like. A drive amount of the actuator 78 is controlled by an optical microscope control unit 75 which is provided at inside of the image control unit 73. The optical microscope control unit 75 includes a memory 76 and a processor 77, and calculates a focus value of the optical microscope 26 at an arbitrary position on the wafer based on a measured value of the Z sensor 25 and a focus map that is stored in the memory 76. The focus value which is calculated by the processor 77 is transmitted to the actuator 78. Although the focus value which is calculated by the optical microscope control unit 75 is a digital value, the drive amount of the actuator 78 is an analog amount. Therefore, a DA converter is provided between the actuator 78 and the image control unit 73, although not illustrated, and the DA converter converts the calculated focus value into an analog data. The focus value as converted is transmitted to the actuator 78. Incidentally, details of the focus map will be described later.

Although a design value of a coordinate of the wafer is already known, the wafer includes a carry error when the wafer is conveyed onto the stage, and a fabrication error of a pattern, and therefore, it is preferable that a visible field of the optical microscope is at least wider than these errors. For example, in a case where the error described above is about 50 μm, when the visible field of the optical microscope is set to about 100 μm, the pattern is substantially put into the visible field. In a case where the pattern is not put into the visible field, the pattern can be detected by observing a periphery of the visible field (search around), although the throughput is retarded. There is a case where an operator of the apparatus carries out the search around by a manual. Or, the search around can automatically be carried out by registering a pattern to be detected as a template image, taking an image of a surrounding of a first visible field by changing the visible field by moving the stage or controlling to deflect the electron beam, and carrying out a pattern matching of the taken image and the template image. When plural pieces of the specific patterns are detected, information of offset, rotation, scaling of a sample position can be calculated, and therefore, even a wafer alignment by a narrow visible field using the electron beam thereafter, can also be carried out.

The stage position information described above is transferred also to a column control unit 70 which controls the column to correct a deflection control signal of the electron beam. The deflector 14 is divided into a position deflector 14A which positions a center of deflection of the electron beam to the sample position, and a scanning deflector 14B which scans the charged particle beam in an object visible field at high speed in order to take an image. Controls of the deflectors are respectively controlled by a deflection control unit 17. For example, in a case where a current position of the stage is deviated from a target coordinate to inside of a deflection range (for example, within 10 μm), the deviation is transferred from the position control unit 71 to the column control unit 70, and an amount of the deviation is added to a deflection instruction value in a state without deviation as a correction amount.

Next, an explanation will be given of a total flow of a defect review SEM according to the present embodiment. The following flow is instructed and controlled basically by the control computer 74.

When an operator of the review SEM instructs start of an automatic defect review (ADR) via a user interface which is displayed on a monitor, the wafer is carried from the load lock chamber 3 into the sample chamber (step 301). Thereafter, an inspection data which records a defect position on the wafer that is acquired by an external outlook inspection device is read by the control computer 74 (step 302). The inspection data stores a defect ID which is attached to a defect and position information of the defect, and the position information of the defect which is included in the read inspection data is transferred to the column control unit 70, the position control unit 71, and the stage control unit 72, and is used for controlling the movement of the stage and an irradiation timing of the electron beam. At step 303, a wafer alignment (global alignment) is executed by the optical microscope, and after finishing the alignment, image taking of the defect position is started.

First, the visible field is moved to the first defect position by moving the stage (step 304), and the focus of the optical microscope is adjusted (step 305). After the adjustment, an image of the defect position is taken and an image data is preserved to a storage means (hard disk or the like) in the control computer 74 along with the defect ID and position information of an image taking position. After taking the image, it is determined whether image taking of all defects is finished (step 307), and when an image of the defect ID which is not taken yet is present, an image of a next defect position is taken by moving the visible field.

In a case where image taking by the optical microscope is finished for all of defects, the visible field is moved to the defect position of the first defect ID by moving the stage (step 308), and an SEM image is taken (step 309). Actually, when the visible field is moved at step 308, the defect included in the optical microscope image is used as an alignment mark, a fine alignment of calculating a center coordinate of the defect is carried out, and a stage moving control is carried out such that the center coordinate of the defect falls into a center of the visible field of the SEM image. Thereafter, it is determined whether the SEM images of all defects are finished to acquire (step 310), and when a defect ID of an image which is not taken yet is present, the visible field is moved and an image of a next defect position is taken by SEM. In the following, steps 308 through 310 are repeated until images of all defects are taken, and when image taking of all defects ID by SEM is finished, the wafer is carried out from the sample chamber 2 to the load lock chamber 3. The acquired SEM image data is preserved at the storage means in the control computer 74 along with the defect ID and the position information of the image taking position similar to the optical microscope image. When image taking of all defects is finished, the taken image of all image data is uploaded from the control computer 74 to a higher server (not illustrated).

Incidentally, a total flow shown in FIG. 2 is an ADR flow for a bare wafer, and in a case of a patterned wafer, the fine alignment is carried out by using an SEM image a visible field size of which is widened. Because in a case of a patterned wafer, a circuit pattern is formed on the wafer, and a pertinent pattern can be used as an alignment pattern for the fine alignment.

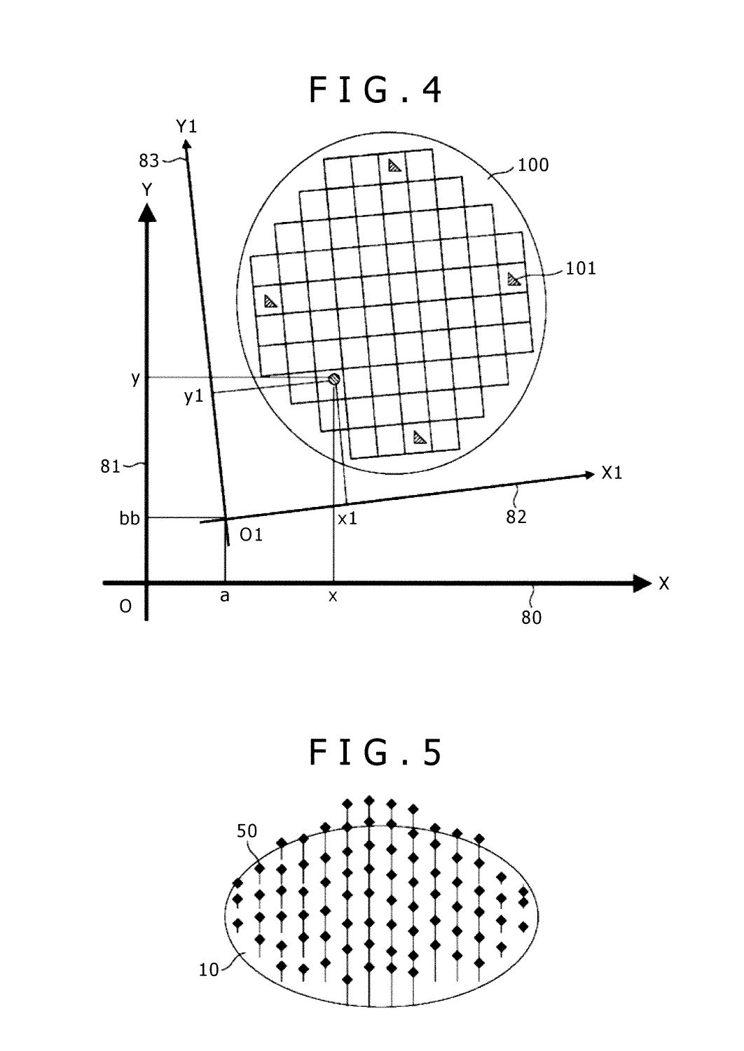

Next, an explanation will be given of the wafer alignment. FIG. 4 shows a relationship between a wafer coordinate system and a stage coordinate system. The stage coordinate system is a coordinate system inherent to the apparatus, and according to the example, a coordinate axis X80 and a coordinate axis Y81 of the stage coordinate system set an origin of the stage as a reference. The stage coordinate system is always constant irrespective of a position or a shape of a wafer. On the other hand, the wafer coordinate system is determined by a position of a pattern formed. The coordinate system of the wafer differs by each wafer, and is determined by an accuracy of forming the pattern. Also, a relationship between the wafer coordinate system and the stage coordinate system differs by an accuracy of carrying the wafer relative to the stage. Therefore, when the wafer coordinate system is formed with the stage coordinate system as a reference, the relationship is expressed by a position relationship between the origins and an angular relationship between the coordinate axes as shown in the diagram.

$$\begin{matrix}x = m ( cos β + sin β tan α ) \cdot x 1 - ( n sin β / cos α ) y 1 + a & ( Equation 1 ) \\ y = m ( sin β + cos β tan α ) \cdot x 1 + ( n cos β / cos α ) y 1 + b & ( Equation 2 )\end{matrix}$$

where

x, y: coordinate values of stage coordinate system

x1, y1: coordinate values of wafer coordinate system

a, b: amount of shifting origins of stage coordinate system and wafer coordinate system (x/y direction)

m: x direction scale correction value of wafer coordinate system

n: y direction scale correction value of wafer coordinate system

α: orthogonal error of wafer coordinate system

β: angular errors of wafer coordinate system and stage coordinate system

As described above, the wafer coordinate system per se differs by each wafer, a relationship between the two coordinate systems is changed at each time of mounting the wafer, and therefore, an alignment operation is carried out before executing an actual observation in the inspection.

An example of a general alignment in a charged particle beam apparatus is shown below. The wafer alignment grossly consists of two of global alignment and a fine alignment.

### *Global Alignment

(1) Mount a wafer on a stage.
(2) Take plural pieces of images of alignment patterns of a wafer (a shape and a coordinate of a wafer coordinate system are previously registered) by a visible field in a wide range (low magnification) by using an optical microscope and collect a coordinate of an observation pattern relative to a stage coordinate.
(3) Calculate a position of the wafer coordinate system relative to a stage coordinate system based on obtained information (for example, a distance between the origins (offset), angles of respective coordinate axes (rotation).

### *Fine Alignment

(1) Collect the coordinate of the observation pattern relative to the stage coordinate by taking the images of plural pieces of the alignment patterns (the shape and the coordinate of the wafer coordinate system are previously registered) in a visible field of a narrow range (high magnification) by an electron beam.
(2) Calculate an elongation/contraction state of the wafer with the stage coordinate system as a reference as a scale correction value by calculating distances from the plural observed pattern coordinates and comparing the distances with design values (the distance of the stage coordinate system is not absolutely correct and strictly speaking, a relative scale value).
(3) Calculate a coordinate correction data of converting the coordinate of the wafer to the stage coordinate system by a position of the wafer coordinate system relative to the stage coordinate system and the scale correction value (a similar effect is achieved also by conversely converting the stage coordinate to the wafer coordinate system).

The position which becomes an observation object of the wafer coordinate system reference relative to the stage coordinate system is converted into the stage coordinate system and the visible field can be moved to a desired image taking position by executing the sequence. Ordinarily, at least 2 pieces or more of the alignment patterns are set in order to convert the wafer coordinate system accurately to the stage coordinate system. For example, as shown in alignment patterns 101 shown in the drawing, the alignment patterns 101 are arranged on four sides such that angular differences of the X coordinate axis and the Y coordinate axis of the wafer coordinate system, and the scale correction value can be measured.

As has been explained above, the operation of the review SEM is necessarily accompanied by image taking by the optical microscope, and it is necessary to adjust the focus of the optical microscope. Here, in controlling the focus of the optical microscope, there are many cases where autofocusing of predicting a just focus value is executed by carrying out an image processing while taking plural sheets of images in a degree of a range which can absorb a thickness error of a wafer and a variation in a height when a stage is moved in background arts. For example, in order to be able to evaluate even a recycled wafer a surface of which is polished once and which has a thin thickness, according to the present system, a focusing range needs to be set to be considerably wide. Therefore, time is taken and a large reduction of a throughput is brought about. For example, in a case where a depth of focus of an optical microscope is 5 μm, when a dispersion of a thickness of a wafer is made to be 100 μm, a focusing range becomes at least 100 μm. Also, when an image acquiring pitch per sheet is made to be 5 μm, the number of sheets becomes 20. When an image acquiring time period per sheet is made to be 0.05 sec, it is necessary to consume a focusing time period of 20 sheets×0.05 s=1 s.

On the other hand, when a Z sensor value is acquired by moving a stage once to directly below a column by intending to use the Z sensor directly below the column 1, and a focus of an optical microscope is controlled based on the value, a time period of an amount of moving the stage is taken. As shown in FIG. 4, a moving distance is a distance of column-optical microscope: L, and L is set assumedly as L=200 mm. In a case where an acceleration of the stage is set to 1 m/s², and a maximum speed thereof is set to 100 mm/s, in order to move a stage by 200 mm, 1.2 s is taken by a simple calculation, and invariably, the reduction in the throughput is unavoidable. Hence, according to the review SEM of the present embodiment, the focus value of the optical microscope is controlled by the following means. Incidentally, according to the present embodiment, the “focus value” is an amount of moving an object lens of the optical microscope 26 which is driven by the actuator 78, and the actuator 78 controls the focus of the optical microscope 26 by moving the object lens in accordance with the focus value designated by the optical microscope control unit 75.

1) Before executing the flow of FIG. 3, a patterned wafer which becomes a reference is previously loaded, autofocusing an image of an entire face of the wafer is executed by the optical microscope, and the just focus value and XY coordinate values at that occasion are acquired. Positions of acquiring the just focus values are lattice points of about 100 through 150 points which are pertinently set on the wafer, and are previously stored in the memory 76 in the optical microscope control unit 75. The number of the lattice points can freely be set via a user interface displayed on a monitor. For example, the number of measuring points can also be reduced by designating such that the focus values are acquired at respective single portions of a total number of wafer chips for acquiring the focus value, or thinning the number of the chips. When the position information of a set arbitrary position is expressed as xi, yi and a just focus value which is acquired at the position (xi, yi) is expressed as Fi, a data expressed by (xi, yi, Fi) is a data which indicates the just focus value of the optical microscope 26 at the arbitrary lattice point position (xi, yi), and hereinafter, a set of data expressed by (xi, yi, Fi) is referred to as a focus map. The formed focus map is stored in the memory 76, and becomes a reference focus map when focusing adjustment of the optical microscope is carried out.

FIG. 5 is a conceptual view expressing a focus map, and is a view which expresses how the focus value is changed by bars substantially over an entire face of the wafer. According to the present embodiment, it is known that a protruded shape is configured at a center portion of the wafer.

2) Next, there is formed an approximate equation which can express a shape of a curved face of the focus value by reading the focus map which is stored in the memory 76 by the processor 77, and fitting the just focus value Fi by a pertinent fitting curve. That is, a dependency of the focus value on a position in a wafer face is calculated. As a fitting curve, for example, a quartic through sextic polynomial with regard to x and y can be used in a case of using an XY coordinate system as a coordinate system of a stage control. Such an approximate polynomial can be calculated by using, for example, a least squares method.

Incidentally, as the coordinate system of the stage control, a coordinate system other than the XY coordinate system of an RO coordinate system or the like can be also be used, and as a fitting curve in this case, for example, a polynomial of R and θ or a polynomial of R cos θ and R sin θ (Fourier expansion equation) or the like can be used.

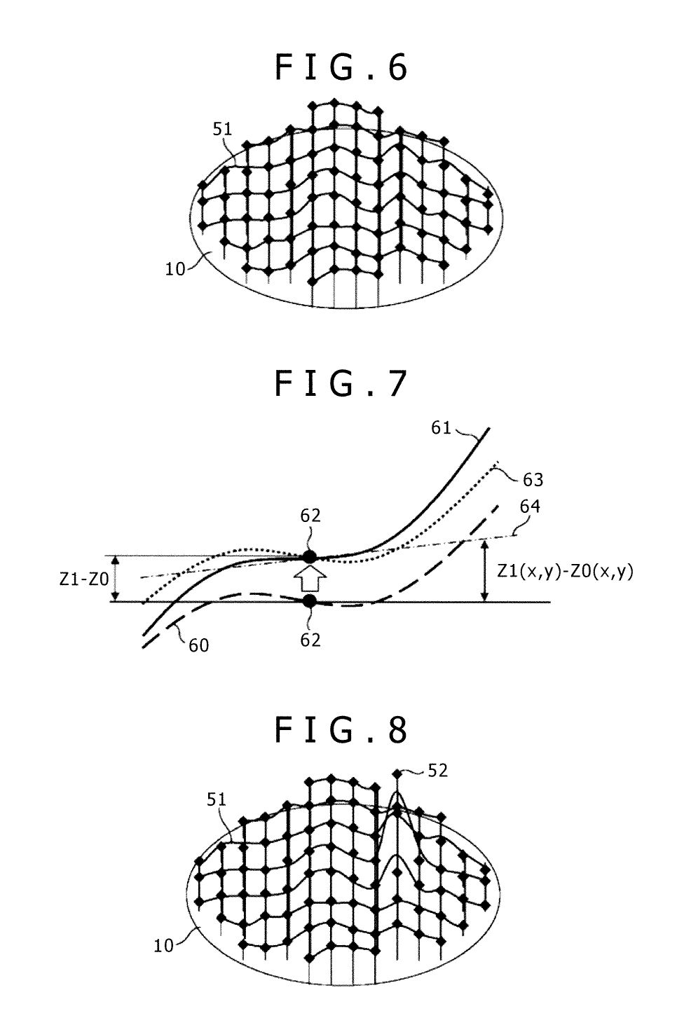

FIG. 6 illustrates an approximate curve face in a case of approximating Fi of the focus map by a quartic equation of x and y. In the following explanation, a mathematical expression of the obtained fitting curve is expressed by F (x, y). A coefficient included in Equation F (x, y) is stored to the memory 76 similar to the focus map.

3) Next, a height of an arbitrary reference position of a reference wafer is measured by the Z sensor, and a coordinate value (X0, Y0) of the reference position is acquired. The control is carried out by instructing the position control unit 71 and the stage control unit 72 to measure a height at the position (X0, Y0) by the optical microscope control unit 75. As the number of points of the reference positions, at least one point is needed. A measured value Z0 of the Z sensor at the position (X0, Y0) is stored to the memory 76, and is used as a reference offset in the focusing adjustment as follows.

4) A wafer which is intended to observe actually is loaded, and a height is measured by the Z sensor at the acquired coordinate (X0, Y0) of the reference offset. The height which is acquired at this occasion is designated by notation Z1. The measurement of Z1 is executed at step 303 or any step before executing step 303.

5) When the wafer alignment using the optical microscope is executed, after moving the visible field to the image taking position, a focus value of an image taking position coordinate is calculated by using the fitting curve that is stored to the memory 76, and the focus value is corrected by adding an offset value which is calculated in accordance with Equation 3 as follows from the reference offset value and a value of a height measurement value Z1 for an object wafer.

F′=F(x,y)+(Z1−Z0) (Equation 3)

Where notation F′ signifies an instruction value to the focus control actuator of the optical microscope.

The focus control of the optical microscope is enabled by the above control flow in a short period of time.

According to the method described above, when the height is measured with regard to one point of the reference coordinate (X0, Y0) immediately after loading, concerning the image taking position of the optical microscope thereafter, when a moved coordinate is determined, the focus value can be calculated at once. Thereby, a time period which is needed for adjusting a focus is only an actual time period for moving the object lens by the actuator for focusing control (positioning operation time period) and an increase in the throughput is anticipated. The larger the number of observation points of the optical microscope, the higher the effect appears more significantly.

Here, caution is required in that the focusing control flow described above is on the premise that the reproducibility of a total of the system is excellent. That is, when the just focusing value which acquires the reference focus map (xi, yi, Fi) and the reference offset value Z0, and a focus value of a wafer which is made to be an object currently are excessively different from each other, the flow of the present embodiment is not established. Ordinarily, a face shape and a warp degree of the wafer differ for each wafer, and therefore, it is very effective for the focusing control flow of the present invention to correct the face shape and the warp described above by holding the wafer by the electrostatic chuck. Naturally, depending on a process, there also is a wafer which can use the control method of the present embodiment without a vacuum chuck.

Also, the offset value for correcting the focus value can also be expressed as a function of a position of a wafer. There is a case where there is an inclination in a thickness of a single body of a wafer depending on a polishing accuracy of the wafer, and in such a case, it is necessary to provide an inclination also in the offset value which corrects the focus value.

In this case, in executing step 3), when heights of plural reference coordinates (X0i, y0i) are measured and the measured values Z0i are approximated by a linear function, the reference offset value Z0 can be expressed as a linear function Z0 (x, y) of a position on a wafer.

On the other hand, at step 4), the height measurement is executed at a coordinate position the same as the reference coordinate (X0i, y0i), and an approximate equation is calculated by the knack the same as that of Z0 by using the plural measured values. At step 5), the function Z0(x, y) and the function Z1(x, y) which are stored in the memory 76 are read, and the focus value is corrected in accordance with the following Equation 4.

F′=F(xi,yi)+{Z1(x,y)−Z0(x,y)} (Equation 4)

An explanation will be given of the reason that the correction of the focus value by (Equation 4) is more effective than that by (Equation 3) in reference to FIG. 7. FIG. 7 is a schematic diagram two-dimensionally showing an error which is brought about in a case of causing an inclination in an observation wafer relative to a wafer which is used when the focus map is formed. An approximate curve 60 which is obtained from the focus map is shown by a dotted line, and a face shape 61 of the observation wafer is shown by a bold line. When the offset value (Z1-Z0) which is obtained from a height that is measured at an offset measuring position 62 is added to the approximate curve 60, a correction equation 63 shown by a dotted line is established. Although the correction equation 63 and the face shape 61 of the observation wafer coincide with each other at the offset measuring position 62 and an accurate focus control is enabled, a deviation is increased by an inclination component by being remote from the position. A base line 64 showing an inclination is shown by a one-dotted chain line in FIG. 7 in order to show that the face shape 61 of the observation wafer is inclined to the approximate curve 60. Although (Equation 3) removes only a simple offset, (Equation 4) removes also the inclination component, and an excellent focusing control is enabled over an entire face of the wafer. When a wafer is carried, a device which uses a holder is comparatively easy to be dispersed in a reproducibility in a height direction of the holder when the holder is mounted on a stage, and therefore, when the inclination is corrected in this way, the correction is effective.

Although the explanation has been given of an example of approximating the offset value by the linear function as described above, other approximate function can also be used naturally. Incidentally, all of the calculation processings explained above are executed by the processor 77.

In a case where even an extremely small focus deviation is unallowable, it is also effective to adopt a method of also using autofocusing which predicts the just focus value by carrying out an image processing while taking plural sheets of images in a narrow range in addition to the focusing control which uses the focus map described above. Inherently, the focus value can be anticipated with the accuracy to some degree by the correction data, and therefore, even the autofocusing which uses images can reduce the number of sheets of image taking. Therefore, the focusing having a high accuracy can be carried out in a comparatively short period of time, and a compatibility of highly fine image acquisition and a comparatively fast throughput can be realized.

Although the explanation has been given of an example of the optical microscope for alignment in the embodiment explained above, a similar effect can also be achieved for focusing a dark-field optical microscope which uses a short wavelength laser. Particularly, in observing a small foreign matter of a bare wafer in which a circuit pattern is not formed, the autofocusing per se using the image processing is difficult, and the effect of the present embodiment which can predict the focus value is therefore higher.

Although the explanation has been given of the charged particle beam apparatus which mounts a single piece of the optical microscope according to the present embodiment, the present invention is similarly applicable also to an apparatus which mounts plural pieces of optical microscopes. Focusing control of a charged particle beam as well as plural optical microscopes can be realized by a single piece of Z sensor, and the cost merit is therefore higher.

As described above, according to the focus controlling method of the present embodiment, focusing of the optical microscope can accurately be realized while restraining an increase in the apparatus cost and a reduction in the throughput.

### Second Embodiment

According to the present embodiment, an explanation will be given of a configuration of a defect review SEM having a function of forming a focus map by removing an abnormal point. The total configuration of the apparatus and the outline operation flow are the same as those of the first embodiment, and therefore, the same explanation will be omitted in the following explanation and an explanation will be given only of a difference therefrom. Also, the drawings which are used in the first embodiment will be pertinently diverted.

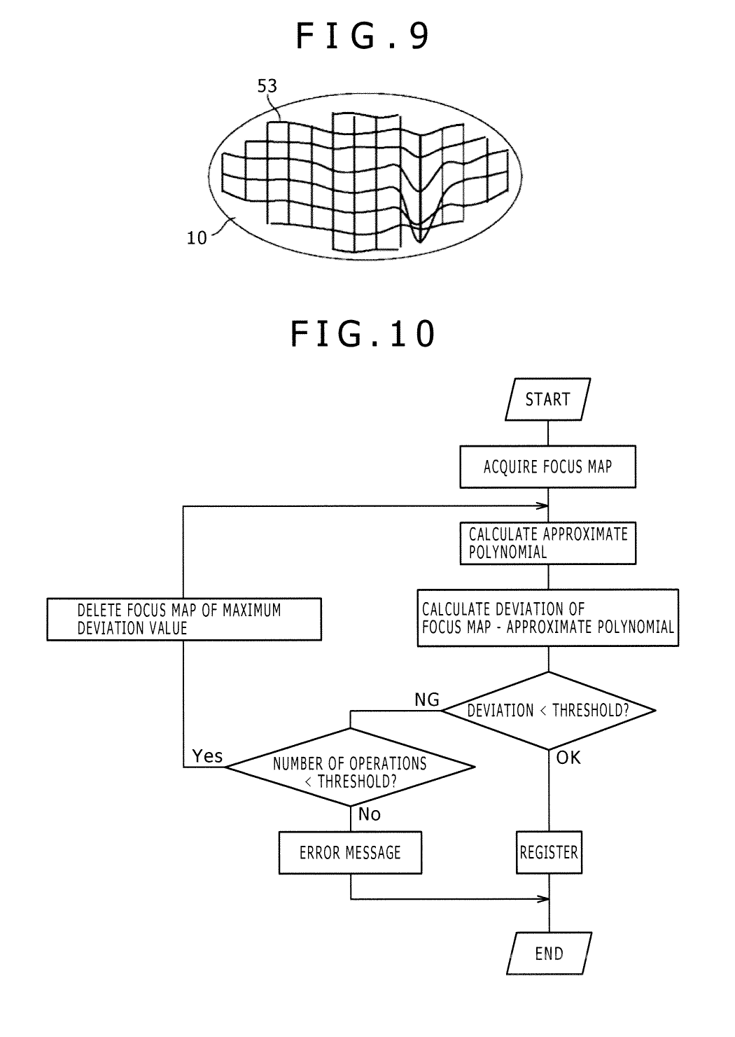

As shown in FIG. 8, when a foreign matter is adhered to a back face of a reference wafer or an electrostatic chuck in forming a reference focus map, a locally raised shape is acquired. When an approximate polynomial is formed by a least squares method based on the result, a local change includes an error as if the focus map were raised at a periphery of the coordinate. (A maximum value becomes an error which is conversely pressed down) There are many cases where the foreign matter is removed by a method of changing a wafer, repeating loading operation, or cleaning the electrostatic chuck. Therefore, in the focus adjustment of the optical microscope thereafter, there is brought about a focusing error having a tendency of conversely dropping down a position where the foreign matter is disposed as shown by FIG. 9.

Hence, according to the present embodiment, in order to confirm whether data which is acquired in forming the focus map is influenced by a foreign matter, the acquired focus map (xi, yi, Fi) is subtracted from the focus map F (x, y) by the approximate equation of the focus map, and a determination is carried out by whether a difference thereof exceeds a threshold. A separation from an experimental equation indicates that a local height change is present at the location. Ordinarily, a variation in a height which is caused by an accuracy of running a stage is frequently a linear or quadratic change, and when an approximate polynomial is set to about a quartic degree, reproduction is substantially enabled. However, in a case where a foreign matter is interposed, a steep change is caused in a very narrow range, and therefore, the change cannot be reproduced by an approximate polynomial of about the quartic degree, as a result, in a case of comparing with a measured value, the deviation is increased. It can be determined whether a correction equation can be formed in a state without a foreign matter by making use of the present phenomenon.

As a threshold of a determination of whether the correction equation is pertinent, when, for example, a value of a depth of focus of the optical microscope 26 is set, at least a state without dimming by a deviation in a focus can be ensured. An acceptability of a focus map forming operation can be determined by integrating a software which outputs a message of register when the determination described above is OK or urging removal of the foreign matter when the determination is NG to the optical microscope control unit 75, and executing the software by the processor 77. On the other hand, in a case where a foreign matter cannot be removed unless the apparatus is leaked such as adherence of a foreign matter to an electrostatic chuck, a countermeasure thereagainst cannot easily be established by an in-line used apparatus of a user.

An influence of the foreign matter is removed by the following method in consideration of such a situation.

An actual operation flow is shown in FIG. 10.

F₀(x, y) which is a fitting curve of a reference focus map is subtracted from the acquired reference focus map (xi, yi, Fi). When a difference exceeds a threshold, it is regarded that there is a foreign matter at a coordinate of a maximum value thereof, and an approximate equation (made to be F₁(x, y)) is formed again by excluding a focus value of the coordinate from the focus map. Next, the focus map (xi, yi, Fi) is subtracted from the approximate equation F₁(x, y) which is formed again. As the focus map which is used at this occasion, there is used a set of data which removes the focus value at the coordinate of the maximum value from the reference focus map. When a subtracted result is within the threshold, the approximate equation is registered as an approximate equation which can remove the influence of the foreign matter. When there is a coordinate at which the focus value is not within the threshold, a next approximate equation F₂(x, y) is formed similarly by excluding the maximum value. As described above, when the calculation is repeated until subtraction results at all coordinates are within the threshold, an approximation equation which can remove the influence of the foreign matter can be obtained.

However, removal of data in a wide range by a gigantic foreign matter, a reflection of a result of removing data by an enormous number of foreign matters can be avoided by determining an upper limit of the number of calculation counts. In such case, a reliability of a formed approximate equation is low, and therefore, it is preferable to output a message which urges a fundamental countermeasure to a user interface on a monitor. For example, there is conceivable a message of “A reliability of a correction equation is lowered. There is a possibility of adhering a foreign matter to an upper face of an electrostatic chuck or a back face of the wafer, and therefore, execution of cleaning or interchanging of a wafer is recommended” or the like.

As described above, a focusing control having an accuracy more excellent than that in the first embodiment can be carried out by providing the apparatus with a function of forming an approximate equation of a focus value by removing an abnormal point.

### Third Embodiment

An explanation will be given of a configuration of a defect review SEM including a function of monitoring an aging deterioration of a focus adjustment accuracy. Similar to the second embodiment, an explanation of a configuration and a function the same as those of the first embodiment will be omitted, and an explanation will be given only of a difference. Further, the drawings which are used in the first embodiment are pertinently diverted.

As described above, the focus control method which has been explained in the first embodiment resides in that the reproducibility with regard to the height direction is excellent, and the method is on the premise that there is not a relative variation with regard to heights of the Z sensor and the optical microscope. However, there is actually a variation in a temperature in a clean room at which a review SEM or other semiconductor inspection/measurement apparatus is installed, which has an influence on a focusing accuracy to no small degree. For example, respective attaching positions of the Z sensor and the optical microscope are relatively displaced by thermal expansion of the sample chamber to which the both are mounted, or a focal point is shifted by elongating or contracting respective internal optical paths. Thereby, there is a possibility of causing a deviation in a focus by changing a relative relationship when the correction data is formed.

The sample chamber is a vacuum vessel, and therefore, when a variation in an atmospheric pressure is caused, the sample chamber is deformed, and the positions of attaching the Z sensor and the optical microscope are relatively displaced, which amounts to a deterioration in a focusing accuracy by the similar reason.

According to the present embodiment, the following sequence is executed with a purpose of removing an influence of a relative displacement with regard to the heights of the Z sensor and the optical microscope by an environmental change described above.

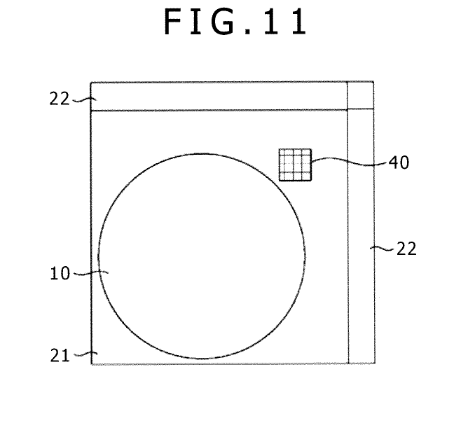

(1) A reference mark member formed with a pattern is attached onto the stage (onto the holder is also acceptable in a case of using the holder) as shown in FIG. 11.
(2) When a correction data is formed, a height Zs by the Z sensor of the reference mark and a focus value Fs of the optical microscope are simultaneously measured and stored to the apparatus.
(3) A height Zs′ of the reference mark by the Z sensor of the reference mark and a focus value Fs' of the optical microscope are measured again periodically in an actual application.
(4) A sum of respective relative displacements is added as a correction data. The correction data can be expressed as described below when the correction equation (Equation 4) is used.

F′=F(x,y)+{Z1(x,y)−Z0(x,y)}+{(Zs′−Zs)+(Fs′−Fs)} (Equation 5)

Incidentally, the above-described sequence (1) through (4) is executed by instructing the position control unit 71 and the stage control unit 72 to measure a position (X0, Y0) and the height at a position of arranging the reference mark member by the optical microscope control unit 75. Also, the calculation processing of Equation 5 is executed by the processor 77. A user interface on a monitor is displayed with a setting screen for setting a time interval or the number of execution counts per unit time of measuring the height and measuring the focus value in order to automatically execute the measurement of the height of the Z sensor and the measurement of the focus value periodically by the optical microscope control unit 75.

A deterioration in an accuracy of a focusing control can be reduced even when the focusing accuracy is deteriorated by an environmental change by executing the sequence described above. Incidentally, although the above-described explanation describes the periodical execution, an interface which can execute the height measurement and the focus value measurement at once even by a determination of a user may be configured. As described above, the charged particle beam apparatus which can carry out the focusing control with an accuracy equal or higher than a constant level can always be realized by the present embodiment.

### LIST OF REFERENCE SIGNS

1 column,
2 sample chamber,
3 load lock,
4 mount,
5 vacuum pump,
6 frame,
10 wafer,
11 electron gun,
12 electron beam,
13 electron lens,
14 deflector,
14A position deflector,
14B scanning deflector,
15 detector,
16 electron lens,
17 deflection control unit,
21 stage,
22 bar mirror,
23 interferometer,
24 electrostatic chuck,
25 Z sensor,
26 optical microscope,
31 carrier robot,
32 vacuum side gate valve,
33 atmosphere side gate valve,
40 reference mark,
50 focus map,
51 polynomial approximation,
52 singular point,
53 focus shift curve,
60 approximate polynomial curve,
61 wafer face shape in observation,
62 offset measuring position,
63 correction equation,
64 base line,
70 column control unit,
71 position control unit,
72 stage control unit,
73 image control unit,
74 control computer,
75 optical microscope control unit,
76 memory,
77 processor,
80 stage coordinate axis X,
81 stage coordinate axis Y,
82 wafer coordinate axis X,
83 wafer coordinate axis Y,
90 observation object pattern,
91 observation range,
95 current observation pattern,
96 current reference pattern,
97 past observation pattern,
98 past reference pattern,
100 conceptual shape of wafer coordinate system, and
101 conceptual shape of wafer coordinate system of reference pattern.

1. A charged particle beam apparatus comprising:
a charged particle optical column of irradiating a wafer mounted on a stage with a primary charged particle beam, detecting a generated secondary electron or reflection electron, and outputting a detection signal;
a Z sensor of measuring a height of the wafer;
a position measuring means for measuring a moving amount in an in-plane direction of the stage;
an optical microscope of taking an image of the wafer by detecting a reflecting beam or a scattering beam provided by irradiating the wafer with a beam; and
a control unit of adjusting a focal point of the optical microscope,
wherein the control unit calculates a focus value of the optical microscope at an image taking position of the optical microscope on a surface of the wafer from a relationship between a dependency of a focus value of the optical microscope on an in-plane position of the wafer and a measured value of the position measuring means, and corrects the calculated focus value by using a measured value of the Z sensor at a prescribed reference position of the wafer.

2. The charged particle beam apparatus according to claim 1, wherein the control unit calculates the focus value of the optical microscope by storing a difference between the measured value of the Z sensor at the reference position and the measured value of the Z sensor at a predetermined image taking position of the optical microscope as an offset data, and adding the offset data to the focus value before the correction.

3. The charged particle beam apparatus according to claim 1, wherein the control unit calculates the focus value by approximating the dependency of the focus value of the optical microscope on the in-plane position of the wafer and calculating the polynomial.

4. The charged particle beam apparatus according to claim 3, wherein the control unit generates the approximate polynomial by setting a plurality of lattice points on the wafer, determining the focus value by calculating a focusing condition of the optical microscope for the plurality of lattice points, and fitting the focus value by a piece of position information of the lattice point.

5. The charged particle beam apparatus according to claim 2, wherein the measured values of the Z sensor acquired at a plurality of positions on the wafer are used as the offset data.

6. The charged particle beam apparatus according to claim 5, wherein the measured values of the Z sensor acquired at the plurality of positions are approximated by an approximate equation with regard to the positions on the wafer, and the offset data is calculated by using the approximate equation.

7. The charged particle beam apparatus according to claim 4, further comprising:
a screen display means for displaying an image taken by the optical microscope,
wherein in a case where differences between the focus value calculated by the polynomial and the focus values at the plurality of lattice points exceed a prescribed threshold, a piece of information indicating that the difference exceeds the threshold is displayed on the screen display means.

8. The charged particle beam apparatus according to claim 7, wherein the control unit calculates again the approximate polynomial by excluding the focus value of the lattice point at which the difference exceeds the threshold.

9. The charged particle beam apparatus according to claim 1, further comprising:
a reference mark member having a reference mark and held on the stage; and
a storage means for storing the measured value of the Z sensor for the reference mark and the focus value of the optical microscope,
wherein a height of the reference mark is measured by the Z sensor, and the focus value for the reference mark is measured by the optical microscope in applying the apparatus; and
wherein a difference between the measured value of the Z sensor and the focus value stored in the storage means is added to the focus value on the wafer.

10. The charged particle beam apparatus according to claim 1, further comprising:
an electrostatic chuck provided on the stage,
wherein the wafer is held by the electrostatic chuck.

11. A charged particle beam apparatus comprising:
a charged particle optical column of irradiating a wafer mounted on a stage with a primary charged particle beam, detecting a generated secondary electron or reflection electron, and outputting a detection signal;
a Z sensor of measuring a height of the wafer;
a laser interferometer of measuring a moving amount in an in-plane direction of the stage;
an optical microscope of taking an image of the wafer by detecting a reflection beam or a scattering beam obtained by irradiating the wafer with a beam;
a storage means for storing a piece of information of a position of a surface of the wafer and a focus value of the optical microscope at the position as a focus map; and
a processor of calculating a focus value of the optical microscope at an arbitrary position on the wafer by fitting the focus map by an approximate equation, and correcting the calculated focus value by using a piece of information of a height of a prescribed reference position on the surface of the wafer measured by the Z sensor.
